(19) United States
(12) Patent Application Publication
(10) Pub. No.: US 2025/0050910 A1
(43) Pub. Date: Feb. 13, 2025

(54) METHOD FOR PLANNING OPTIMAL DRIVING BEHAVIOR FOR AN AT LEAST PARTIALLY AUTONOMOUSLY DRIVING VEHICLE

(71) Applicant: Robert Bosch GmbH, Stuttgart (DE)

(72) Inventors: Marcel Hallgarten, Ehningen (DE); Martin Stoll, Renningen (DE)

(21) Appl. No.: 18/786,964

(22) Filed: Jul. 29, 2024

(30) Foreign Application Priority Data
Aug. 11, 2023 (DE) 10 2023 207 728.0

(51) Int. Cl. B60W 60/00

(52) U.S. Cl. CPC B60W 60/0011

(57) ABSTRACT

A method for planning an optimal driving behavior for an at least partially autonomously driving vehicle. The method includes: obtaining sensor data of the vehicle; ascertaining a first evaluation function which assigns a quality to each possible state of the vehicle at discrete points in time within a planning horizon of the vehicle based on the sensor data; ascertaining a local optimum of the first evaluation function at each discrete point in time; ascertaining a candidate trajectory which includes a temporal sequence of the local optima; evaluating the candidate trajectory using a second evaluation function which evaluates state transitions between successive states of the at least one candidate trajectory; selecting an optimal candidate trajectory from the candidate trajectories based on the first and second evaluation functions; and transmitting the selected at least one optimal candidate trajectory to a control unit of the vehicle.

### CROSS REFERENCE

The present application claims the benefit under 35 U.S.C. § 119 of German Patent Application No. DE 10 2023 207 728.0 filed on Aug. 11, 2023, which is expressly incorporated herein by reference in its entirety.

### FIELD

The present invention relates to a method for planning an optimal driving behavior for an at least partially autonomously driving vehicle.

### BACKGROUND INFORMATION

One possible goal of autonomous driving for a vehicle is to control the vehicle on the basis of sensor data in such a way that a defined destination is reached as quickly, comfortably and safely as possible, for example without causing collisions or violating traffic regulations.

This driving task can be subdivided into the subtasks of perception, prediction, planning and control. The task of perception is to extract relevant information from the sensor data, such as the position of objects (other vehicles or road users), identify road markings and recognize traffic signs or the like. Since the recognized objects are usually dynamic obstacles, their future position must subsequently be predicted in order to avoid collisions. Based on this, the task of planning is to generate a trajectory that is to be controlled in the control subtask.

One special method among the AI-based approaches to trajectory planning is the “End-to-End Interpretable Neural Motion Planner” (NMP) published by Uber ATG. This end-to-end approach spans all of the above-mentioned subtasks and generates a prediction for other road users, on the one hand, and a so-called cost volume, on the other hand, on the basis of so-called lidar point clouds and HD maps, which comprise information regarding the road layout, speed limit, real-time traffic information, etc., for example. This cost volume assigns a cost value to each possible position in the field of view for each point in time in the planning horizon, which indicates how favorable (or unfavorable) it is to be at this location at this point in time. Various trajectories that the vehicle is in principle capable of executing are subsequently evaluated based on this cost volume. The best trajectory is passed on to a controller, which steers the vehicle along this plan.

This conventional NMP approach uses inputs that are rasterized in a bird's eye view and uses convolutional neural networks (=CNNs) for information processing. In the field of prediction, vectorized inputs that are processed with graph neural networks are increasingly being used. The street graph is linked with information about the ego history and other agents. The probability of this connection being part of the future ego trajectory is subsequently ascertained for each connection between adjacent nodes of the graph. In PGP, various traversals of the graph are then used as the basis for predicting different trajectories.

However, one weakness of NMP is that the plan is generated solely on the basis of sensor data and map information. Accordingly, the trajectory is selected without taking into account the desired route. Although NMP enables collision-free driving, it does not offer the option of taking into account a given navigation destination.

Another problem is the marginalization upon the generation of cost volumes and prediction. The reason for this is as follows: in many situations, different behavior options are possible for the ego vehicle. For example, it may be equally permissible to follow the current lane and change to another lane. In addition, other road users can act and react in different ways. Since NMP only generates a cost volume or only one prediction, this represents a marginalization of all possible ego intentions and all developments in the overall scene.

In addition, the trajectory for the ego-vehicle in NMP is selected from a set of randomly generated drivable trajectories by evaluating them on the cost volume and subsequently selecting the best one. On the one hand, this is time-consuming and computationally intensive; on the other hand, the quality of the selected trajectory depends directly on the candidates contained in the set. If the candidates are too primitive, the trajectory selected in this way are under some circumstances significantly worse than the optimum on the given cost volume. If the candidates are highly complex (and also comprise S-curves, for example), the marginalization can result in trajectories that mix different modes being selected. If the modes “decelerate” and “accelerate” in each case have low costs, a trajectory that initially decelerates and then accelerates could be selected as the best candidate, although this behavior is not permissible in the given situation. By generating the ego trajectory without evaluating candidates and by selectively differentiating different modes from one another, such driving behavior of a vehicle can be prevented.

It is an object of the present invention to provide a solution by means of which an improved trajectory for mapping an optimal driving behavior for an at least partially autonomously driving vehicle can be generated in an efficient manner.

### SUMMARY

The object may be achieved by a method for planning an optimal driving behavior for an at least partially autonomously driving vehicle having features of the present invention.

According to a first aspect, the present invention relates to a method for planning an optimal driving behavior for an at least partially autonomously driving vehicle. According to an example embodiment of the present invention, the method includes the following steps:

In a first step, sensor data comprising information regarding the environment and/or status of the vehicle is obtained.

In a second step, a first evaluation function is ascertained, which is designed to assign a quality to each possible state of the vehicle at discrete points in time within a planning horizon of the vehicle on the basis of the sensor data.

In a third step, at least one local optimum of the first evaluation function is ascertained at each discrete point in time, wherein the at least one local optimum represents a possible state of the vehicle at the associated discrete point in time.

In a fourth step, at least one candidate trajectory is ascertained, wherein a candidate trajectory consists of a temporal sequence of the local optima.

In a fifth step, the at least one candidate trajectory is evaluated by means of a second evaluation function which evaluates state transitions between successive states of the at least one candidate trajectory.

In a sixth step, at least one optimal candidate trajectory is selected from the at least one candidate trajectories 17 on the basis of the first and second evaluation functions.

In a seventh step, the selected at least one optimal candidate trajectory is transmitted to a control unit of the vehicle for planning the optimal driving behavior of the vehicle.

Some basic aspects of the present invention are described below: The present invention for planning an (ego) trajectory for a vehicle is initially based on the conventional NMP approach and extends this with methods from the PGP approach. The starting point is a marginalized cost volume.

This cost volume is initially reduced to potential waypoints of the vehicle for different modes or behavior options. These waypoints are identified, for example, by means of applying a non-maxima suppression (NMS) to the costs at each time step. Since these potential waypoints can belong to different modes, it is not possible to link them arbitrarily without creating a mixture of different modes. In order to be able to differentiate between the modes, a probability is determined for each pair of successive time steps consisting of potential waypoints, similar to PGP, which probability describes how likely it is that they belong to the same mode or how likely it is that both are connected by a trajectory.

By combining the identified potential waypoints and the probability that they belong to the same mode, the planning of a trajectory can also be represented visually as a traversal of a tree whose nodes are the waypoints and whose edge weights are the probabilities. The current position of the ego vehicle is used as the root node. The edge weight between the root node and all possible first waypoints is initially set to zero. An optimal traversal through the tree can subsequently be ascertained for each of the waypoints of the last time step, for example by means of dynamic programming. The traversals correspond to different modes. By subsequently examining only optimal traversals, it is ensured that impermissible mixtures of modes are no longer taken into account. In addition, this selection means that not all permutations of potential waypoints need to be examined. The number of optimal traversals corresponds to the number of possible waypoints in the last time step.

Each traversal represents a possible rough trajectory. In the next step, waypoints are decoded from these, wherein it is to be ensured that the resulting trajectory is drivable and comfortable and that it follows the desired route. For this purpose, a neural network, for example an MLP (=multilayer perceptron), is trained to decode drivable trajectories for a vehicle from the coordinates and costs of the nodes. For each of these trajectories, the deviation between the final position and the route is then compared an in this way an optimal trajectory for the ego vehicle is selected.

A corresponding architecture, which substantially depicts the scenario described above, is represented visually in FIG. 3.

In one possible configuration of the method of the present invention, the information for the sensor data comprises at least one item of map information. In this way, the trajectory to be generated can be optimally and precisely adjusted to different scenarios.

In one possible configuration of the method of the present invention, the first evaluation function is designed in each case as a cost volume. As a result, an efficient planning of the driving behavior of the vehicle is achieved.

In one possible configuration of the method of the present invention, the temporal sequence of the local optima consists of a first local optimum and a second local optimum, which are arranged relatively close to one another. As a result, the most realistic depiction of the possible driving behavior of the vehicle is achieved.

In one possible configuration of the method of the present invention, the at least one optimal candidate trajectory is optimized prior to the transmission step. As a result, the planned driving behavior of the vehicle is improved and user-friendliness for the driver of the vehicle is increased.

In one possible configuration of the method of the present invention, the first evaluation function is mapped via a neural network. As a result, the advantage of automating the planning of the optimal driving behavior is achieved.

According to a second aspect, the present invention relates to a computer program comprising machine-readable instructions that, when executed on one or more computers and/or computer instances, cause the computer or computer instances to execute the method according to the present invention.

According to a third aspect, the present invention relates to a machine-readable data carrier and/or download product comprising the computer program of the present invention.

According to a fourth aspect, the present invention relates to one or more computers and/or computer instances with the computer program, and/or with the machine-readable data carrier and/or the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows a schematic flow chart of the method 100 for planning an optimal driving behavior for an at least partially autonomously driving vehicle 10, according to an example embodiment of the present invention.

FIG. 2 shows a schematic overview of a module-based architecture for the method according to the present invention according to one example embodiment of the present invention.

FIG. 3 shows a schematic representation of an architecture for the method 100 according to an example embodiment of the present invention.

### DETAILED DESCRIPTION OF EXAMPLE EMBODIMENTS

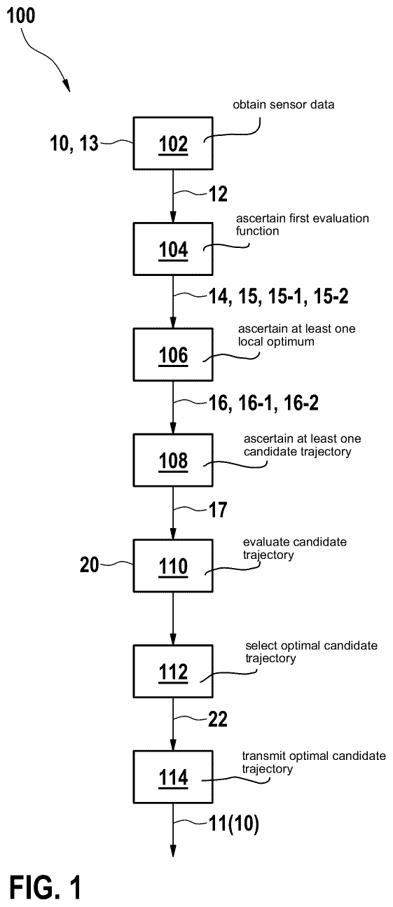

FIG. 1 shows a schematic flow chart of the method 100 for planning an optimal driving behavior for an at least partially autonomously driving vehicle 10.

In a first step 102, sensor data 12 is obtained, which data comprise information regarding an environment and/or status information 13 of the vehicle 10. The information 13 can, for example, be in the form of an item of map information, which is transmitted to the vehicle 10 by the vehicle 10 itself and/or partially generated by an external service provider.

In a second step 104, a first evaluation function 14 is ascertained, which is designed to assign a quality to each possible state of the vehicle 10 at discrete points in time 15 within a planning horizon of the vehicle 10 on the basis of the sensor data 12. For example, sensor data 12 such as HDMap map information can be used as the input. A corresponding volume of costs is generated as an output. The planning horizon can have a spatial and/or temporal component. The first evaluation function 14 can be designed as a cost volume.

In a third step 106, at least one local optimum 16 of the first evaluation function is ascertained 106 at each discrete point in time 15, wherein the at least one local optimum 16 represents a possible state of the vehicle 10 at the associated discrete point in time 15. This possible state of the vehicle 10 can be detected by various sensors, such as lidar, radar or visual sensors, such as RGB cameras. More generally, it can also be said in this connection that it represents an aspect of the present invention to optimize trajectories with the aid of a suitable evaluation function for states or state transitions (dynamics). Suitable optimization methods can be used for this purpose.

In a fourth step 108, at least one candidate trajectory 17 is ascertained, wherein a candidate trajectory 17 consists of a temporal sequence of the local optima 16. This can be a corresponding combinatorial approach.

Optionally, the temporal sequence of the local optima 16 can consist of a first local optimum 16-1 at a first discrete point in time 15-1 and a second local optimum 16-2 at a second discrete point in time 15-2, which are arranged relatively close to one another.

In a fifth step 110, the at least one candidate trajectory 17 is evaluated by means of a second evaluation function 20 which evaluates state transitions between successive states of the at least one candidate trajectory 17. The second evaluation function 20 optionally specifies a quality of the at least one candidate trajectory 17.

In a sixth step 112, at least one optimal candidate trajectory 22 is selected from the at least one candidate trajectories 17 on the basis of the first and second evaluation functions 14, 20.

In a seventh step 114, at least one optimal candidate trajectory 22 is transmitted to a control unit 11 of the vehicle 10 for planning the optimal driving behavior of the vehicle 10.

Optionally, prior to the transmission step 114, the at least one optimal candidate trajectory 22 can be optimized, for example by smoothing. Furthermore, the at least one optimal candidate trajectory 22 can optionally be optimized locally on the basis of a combined cost function.

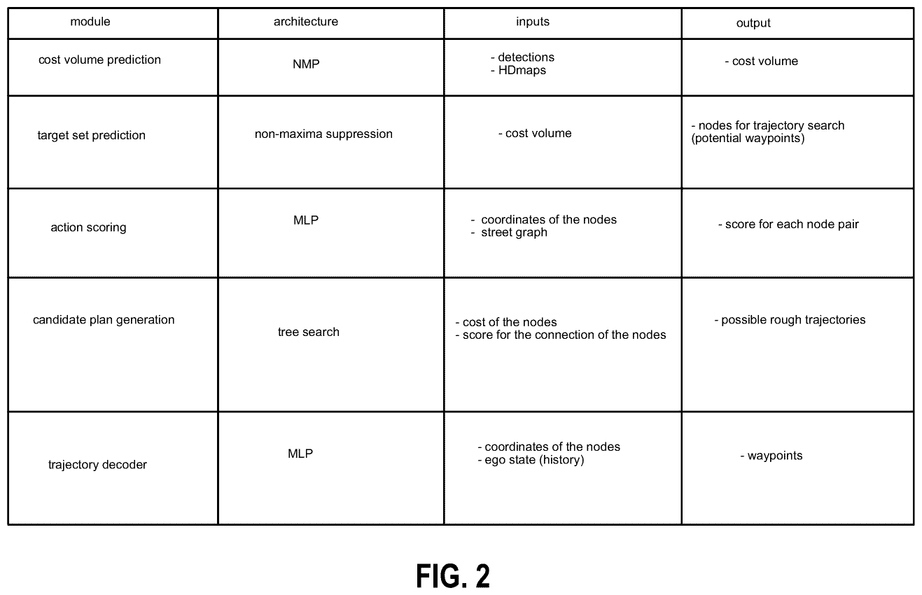

FIG. 2 shows a schematic and exemplary overview of a module-based architecture for the method according to the invention according to one embodiment of the present invention.

The individual modules of the architecture can be trained as follows:
Cost volume prediction: analogous to original NMP with max-margin loss
Target set prediction: no trainable parameters
Action scoring: negative log likelihood with teacher forcing: The nodes closest to the ground truth waypoints are shifted to the gt coordinates. The negative log likelihood of the connection between the gt nodes is subsequently optimized.
Candidate plan generation: no trainable parameters
Trajectory decoder: L2 loss: The L2 loss of the waypoints is optimized for the traversal whose distance to the gt is the smallest.

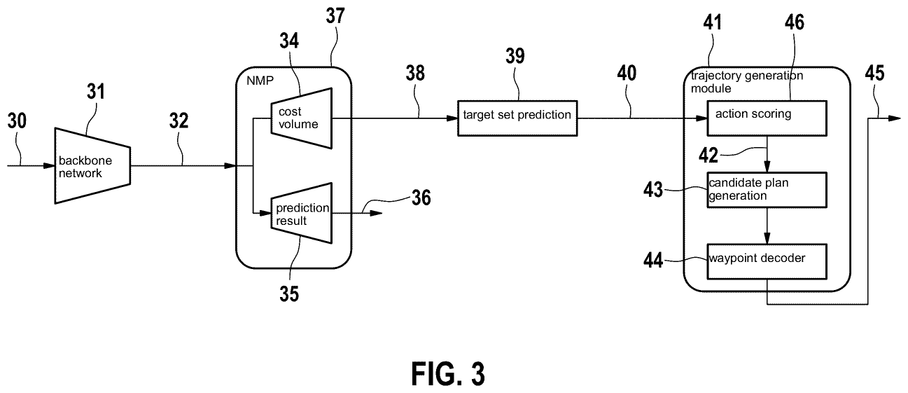

FIG. 3 shows a schematic representation of an architecture for the method 100 according to an embodiment of the present invention with reference to the table of FIG. 2.

The individual modules listed in FIG. 2 are represented graphically with the corresponding inputs and outputs of the architecture in order to obtain an optimal candidate trajectory for a vehicle on the basis of sensor data, such as map information at the input at the output of the architecture.

### LIST OF REFERENCE NUMERALS

10 Vehicle
11 Control unit
12 Sensor data
13 Environment and/or status information
14 First evaluation function
15, 15-1, 15-2 Discrete point in time
16, 16-1, 16-2 Local optimum
17 Candidate trajectory
20 Second evaluation function
22 Optimal candidate trajectory
30 Input data/detected HD maps
31 Backbone network
32 Latent features
34 Cost volume
35 Prediction
36 Prediction result
37 “End-to-End Interpretable Neural Motion Planner (NMP)” module
38 Cost volume output
39 Target set prediction
40 Potential waypoints/candidate waypoints
41 “Trajectory generation” module
42 Score to each edge of graph
43 Candidate plan generation
44 Waypoint decoder
45 Waypoints (output)
46 Action scoring

What is claimed is:

1. A method for planning an optimal driving behavior for an at least partially autonomously driving vehicle, comprising the following steps:
obtaining sensor data which include information regarding an environment of the vehicle and/or status information of the vehicle;
ascertaining a first evaluation function which is configured to assign a quality to each possible state of the vehicle at discrete points in time within a planning horizon of the vehicle based on the sensor data;
ascertaining at least one local optimum of the first evaluation function at each of the discrete points in time, wherein the at least one local optimum represents a possible state of the vehicle at the discrete point in time;
ascertaining at least one candidate trajectory, wherein each candidate trajectory includes a temporal sequence of the local optima;
evaluating the at least one candidate trajectory using a second evaluation function which evaluates state transitions between successive states of the at least one candidate trajectory;
selecting at least one optimal candidate trajectory from the at least one candidate trajectories based on the first and second evaluation functions; and
transmitting the selected at least one optimal candidate trajectory to a control unit of the vehicle for planning the optimal driving behavior of the vehicle.

2. The method according to claim 1, wherein the information for the sensor data include at least one item of map information.

3. The method according to claim 1, wherein the first evaluation function is in each case a cost volume.

4. The method according to claim 1, wherein the at least one optimal candidate trajectory is optimized prior to the transmission step.

5. The method according to claim 1, wherein the temporal sequence of the local optima includes a first local optimum and a second local optimum, which are arranged relatively close to one another.

6. The method according to claim 1, wherein the first evaluation function is mapped via a neural network.

7. A non-transitory machine-readable data carrier on which is stored a computer program including machine-readable instructions for planning an optimal driving behavior for an at least partially autonomously driving vehicle, the instructions, when executed by one or more computers and/or computer instances, causing the one or more computers and/or computer instances to perform the following steps:
obtaining sensor data which include information regarding an environment of the vehicle and/or status information of the vehicle;
ascertaining a first evaluation function which is configured to assign a quality to each possible state of the vehicle at discrete points in time within a planning horizon of the vehicle based on the sensor data;
ascertaining at least one local optimum of the first evaluation function at each of the discrete points in time, wherein the at least one local optimum represents a possible state of the vehicle at the discrete point in time;
ascertaining at least one candidate trajectory, wherein each candidate trajectory includes a temporal sequence of the local optima;
evaluating the at least one candidate trajectory using a second evaluation function which evaluates state transitions between successive states of the at least one candidate trajectory;
selecting at least one optimal candidate trajectory from the at least one candidate trajectories based on the first and second evaluation functions; and
transmitting the selected at least one optimal candidate trajectory to a control unit of the vehicle for planning the optimal driving behavior of the vehicle.

8. One or more computer and/or computer instances comprising comprising non-transitory machine-readable data carrier on which is stored a computer program including machine-readable instructions for planning an optimal driving behavior for an at least partially autonomously driving vehicle, the instructions, when executed by the one or more computers and/or computer instances, causing the one or more computers and/or computer instances to perform the following steps:
obtaining sensor data which include information regarding an environment of the vehicle and/or status information of the vehicle;
ascertaining a first evaluation function which is configured to assign a quality to each possible state of the vehicle at discrete points in time within a planning horizon of the vehicle based on the sensor data;
ascertaining at least one local optimum of the first evaluation function at each of the discrete points in time, wherein the at least one local optimum represents a possible state of the vehicle at the discrete point in time;
ascertaining at least one candidate trajectory, wherein each candidate trajectory includes a temporal sequence of the local optima;
evaluating the at least one candidate trajectory using a second evaluation function which evaluates state transitions between successive states of the at least one candidate trajectory;
selecting at least one optimal candidate trajectory from the at least one candidate trajectories based on the first and second evaluation functions; and
transmitting the selected at least one optimal candidate trajectory to a control unit of the vehicle for planning the optimal driving behavior of the vehicle.
